(19) United States
(12) Patent Application Publication
(10) Pub. No.: US 2017/0257624 A1
(43) Pub. Date: Sep. 7, 2017

(54) 3D DISPLAY DEVICE AND SENSING METHOD FOR 3D DISPLAY DEVICE

(71) Applicant: ZTE CORPORATION, Shenzhen City (CN)

(72) Inventors: Xiaoliang ZHANG, Shenzhen City (CN); Lei FENG, Shenzhen City (CN); Weishan SUN, Shenzhen City (CN)

(73) Assignee: ZTE CORPORATION, Shenzhen City (CN)

(21) Appl. No.: 15/511,418

(22) PCT Filed: Mar. 27, 2015
(86) PCT No.: PCT/CN2015/075266

§ 371 Date: Mar. 15, 2017

(30) Foreign Application Priority Data
Sep. 15, 2014 (CN) 201410468176.X

(51) Int. Cl. H04N 13/04; G06F 3/041; G06F 3/044

(52) U.S. Cl. CPC H04N 13/0497; G06F 3/044; G06F 3/0416; G06F 2203/04104; H04N 2213/001; G02F 2001/133302

(57) ABSTRACT

A 3D display device and sensing method for a 3D display device are described. The 3D display device includes: a 3D display panel; a touch control sensing layer arranged at one side of a light emergent surface of the 3D display panel, wherein the touch control sensing layer includes a capacitive screen and glass substrate, the capacitive screen configured to sense a touch operation conducted by an operation body on a surface of the glass substrate to generate a first sensing signal, and sense a stereoscopic operation conducted by the operation body at an outside predetermined distance of the glass substrate to generate a second sensing signal; and a drive chip configured to judge a command of operating an image displayed on the 3D display panel from the touch operation according to the first sensing signal and the second sensing signal, to change the image of the 3D display panel.

### CROSS-REFERENCE TO RELATED APPLICATION

This application is the U.S. national phase of PCT Application No. PCT/CN2015/075266 filed Mar. 27, 2015, which claims priority to Chinese Application No. 201410468176.X filed Sep. 15, 2014, the disclosures of which are incorporated in their entirety by reference herein.

### TECHNICAL FIELD

The document relates to the field of three dimensional display.

### BACKGROUND

As the three dimensional 3D movie Avatar is on hot line, 3D technologies begin to be used in more and more movies, and the number of audience is larger and larger, and cool display effects of 3D display are more and more approved recognized by people. As sources of 3D programs becomes increasingly rich, 3D televisions have entered thousands of households as well. More than half of new arrivals televisions per year have 3D display functions. Cell phones and tablet computers, as mobile terminals, will also be an important field of the 3D display.

At present, technologies capable of air or stereo interaction are divided into several categories as follows. One of them is to collect changes in position and movement of a human finger by a plurality of cameras to obtain the position of the finger in the air and implement stereo interaction operations. However, for mobile devices, a major disadvantage of the scheme is that more than two cameras need to be disposed externally, rather than the cameras built in the terminal.

Another type is to utilize an external object as an identified object to implement stereo operation and interaction functions. However, a disadvantage of the scheme is that an interactive operating rod needs to be arranged externally, thus the scheme is inconvenient in use.

A further type is to utilize self capacitance of a capacitive touch screen to implement floating touch above the touch screen. However, ghost points will occur when there is multi-touch, therefore, the real touch place of the finger cannot be recognized and the scheme has great limitation in use.

### SUMMARY

The following is a summary of the subject matter described in detail herein. The summary is not intended to limit the protection scope of the claims.

Embodiments of the present disclosure provide a 3D display apparatus and a sensing method for the 3D display apparatus, such that a mobile terminal does not need to be arranged externally with cameras and interactive operating equipment and only hardware carried by the mobile terminal is required to implement 3D stereo display functions.

An embodiment of the present disclosure provides a 3D display apparatus including a 3D display panel, a touch sensing layer and a driver chip.

The 3D display panel is arranged to form a 3D display image.

The touch sensing layer is provided at a light-out side of the 3D display panel. The touch sensing layer includes a capacitive screen and a glass substrate. Herein, the glass substrate is laid on the capacitive screen, and the capacitive screen is arranged to sense a touch operation of an operating body on a surface of the glass substrate to generate a first sensing signal and sense a stereo operation of the operating body at a predefined distance outside the glass substrate to generate a second sensing signal.

The driver chip is arranged to determine an operation command of the touch operation on the image displayed on the 3D display panel according to the first sensing signal to change the image of the 3D display panel; and arranged to determine an operation command of the stereo operation on the image displayed on the 3D display panel according to the second sensing signal to change the image of the 3D display panel.

The capacitive screen includes a first capacitive layer and a second capacitive layer.

The first capacitive layer is a mutual capacitive structure, and is arranged to sense the touch operation of the operating body on the surface of the glass substrate to generate the first sensing signal.

The second capacitive layer is a self capacitive structure, and is laid on the first capacitive layer and located between the glass substrate and the first capacitive layer. The second capacitive layer is arranged to sense the stereo operation of the operating body at the predefined distance outside the glass substrate to generate the second sensing signal.

The 3D display apparatus further includes a signal monitoring chip, a signal determining chip and a signal extraction chip.

The signal monitoring chip is arranged to collect the first sensing signal and the second sensing signal.

The signal determining chip is arranged to determine a comparison result of intensities of the first sensing signal and the second sensing signal.

The signal extraction chip is arranged to extract the first sensing signal and send the first sensing signal to the driver chip when the intensity of the first sensing signal is greater than the intensity of the second sensing signal, and extract the second sensing signal and send the second sensing signal to the driver chip when the intensity of the second sensing signal is greater than the intensity of the first sensing signal.

The driver chip includes a first coordinate determining structure, a first data acquiring structure, a first command determining structure and a first image output structure.

The first coordinate determining structure is arranged to determine a coordinate position of touch of the touch operation on the glass substrate.

The first data acquiring structure is arranged to determine an image content corresponding to the coordinate position.

The first command determining structure is arranged to determine an operation command corresponding to the image content according to the image content.

The first image output structure is arranged to change the image of the 3D display panel according to the operation command.

The driver chip further includes a second coordinate determining structure, a second data acquiring structure, a second command determining structure and a second image output structure.

The second coordinate determining structure is arranged to determine a vertical coordinate position of the stereo operation relative to the glass substrate and a plane coordinate position of a projection of the stereo operation on a surface of the glass substrate according to the second sensing signal.

The second data acquiring structure is arranged to determine an image content operated by an interactive operation according the vertical coordinate position and the plane coordinate position.

The second command determining structure is arranged to determine an operation command corresponding to the image content according to the image content.

The second image output structure is arranged to change the image of the 3D display panel according to the operation command.

Herein, the second capacitive layer includes a plurality of sub-regions arranged to sense stereo operations in different sub-regions to generate a plurality of second sensing signals.

An embodiment of the present disclosure provides a sensing method for the 3D display apparatus including:

collecting a first sensing signal and a second sensing signal;

determining a comparison result of intensities of the first sensing signal and the second sensing signal; and

extracting the first sensing signal and send the first sensing signal to a driver chip when the intensity of the first sensing signal is greater than the intensity of the second sensing signal; and extract the second sensing signal and send the second sensing signal to the driver chip when the intensity of the second sensing signal is greater than the intensity of the first sensing signal, such that the driver chip determines an operation command according to the first sensing signal or the second sensing signal to change an image of a 3D display panel.

Herein, the step that the driver chip determines an operation command according to the first sensing signal includes:

determining a coordinate position of touch of a touch operation on a glass substrate according to the first sensing signal;

determining an image content corresponding to the coordinate position; and

determining an operation command corresponding to the image content according to the image content.

Herein, the step that the driver chip determines an operation command according to the second sensing signal includes:

determining a vertical coordinate position of a stereo operation relative to the glass substrate and a plane coordinate position of a projection of the stereo operation on a surface of the glass substrate according to the second sensing signal;

determining an image content operated by an interactive operation according the vertical coordinate position and the plane coordinate position; and

determining an operation command corresponding to the image content according to the image content.

Herein, the step of determining the vertical coordinate position of the stereo operation relative to the glass substrate includes:

acquiring a signal value of the second sensing signal; and

acquiring a vertical coordinate position of an operating body according to a corresponding relationship, pre-stored in the 3D display apparatus, between the signal value and the vertical coordinate position.

An embodiment of the present disclosure further provides a computer readable storage medium where computer executable instructions are stored. The computer executable instructions are used for executing the method described above.

The technique scheme described above of the present disclosure has at least the following beneficial effects.

The 3D display apparatus according to the embodiments of the present disclosure uses its built-in capacitive screen to collect stereo touch signals above a surface of a glass substrate and form a terminal with stereo display and interactively operational functions together with a 3D display panel, such that the 3D display apparatus according to the embodiments of the present disclosure have good portability, and can implement stereo multi-touch. Therefore, more application scenarios of operations can be implemented, and the user experience is greatly enhanced.

Other aspects can be understood upon reading and understanding of the accompanying drawings and the detailed description.

### BRIEF DESCRIPTION OF THE DRAWINGS

FIG. 1 is a structural schematic diagram of a 3D display apparatus in accordance with an embodiment of the present disclosure.

FIG. 2 is a schematic diagram of 3D display in accordance with an embodiment of the present disclosure.

FIG. 3 is a schematic diagram of 2D display in accordance with an embodiment of the present disclosure.

FIG. 4 is a touch schematic diagram of self capacitance in accordance with an embodiment of the present disclosure.

FIG. 5 is a touch schematic diagram of mutual capacitance in accordance with an embodiment of the present disclosure.

FIG. 6 is a flow chart of main steps of a sensing method in accordance with an embodiment of the present disclosure.

FIG. 7 is a flow chart one of step 63 in FIG. 6 in accordance with an embodiment of the present disclosure.

FIG. 8 is a flow chart two of step 63 in FIG. 6 in accordance with an embodiment of the present disclosure.

FIG. 9 is a flow chart of step 6321 in FIG. 8 in accordance with an embodiment of the present disclosure.

### DETAILED DESCRIPTION

The present disclosure will be described in detail in conjunction with the accompanying drawings and specific embodiments.

The embodiments of the present disclosure provide a 3D display apparatus and a sensing method for the 3D display apparatus. According to the 3D display apparatus and the sensing method for the 3D display apparatus, a capacitive screen 121 built in the 3D display apparatus is used to collect stereo touch signals above a surface of a glass substrate 122. The capacitive screen 121 and 3D display panel 11 form a terminal with stereo display and interactively operational functions. In addition, the 3D display apparatus in embodiments of the present disclosure can implement stereo multi-touch to implement more application scenarios of operations, thereby greatly enhancing the user experience.

As shown in FIG. 1, an embodiment of the present disclosure provides a 3D display apparatus including a 3D display panel 11, a touch sensing layer 12 and a driver chip 13.

The 3D display panel 11 is arranged to form a 3D display image.

The touch sensing layer 12 is provided at a light-out side of the 3D display panel 11. The touch sensing layer 12 includes a capacitive screen 121 and a glass substrate 122. Herein, the glass substrate 122 is laid on the capacitive screen 121. The capacitive screen 121 is arranged to sense a touch operation of an operating body on a surface of the glass substrate 122 to generate a first sensing signal, and sense a stereo operation of the operating body at a predefined distance outside the glass substrate 122 to generate a second sensing signal.

The driver chip 13 is arranged to determine an operation command of the touch operation to the image displayed on the 3D display panel 11 according to the first sensing signal to change the image of the 3D display panel 11, and to determine an operation command of the stereo operation to the image displayed on the 3D display panel 11 according to the second sensing signal to change the image of the 3D display panel 11.

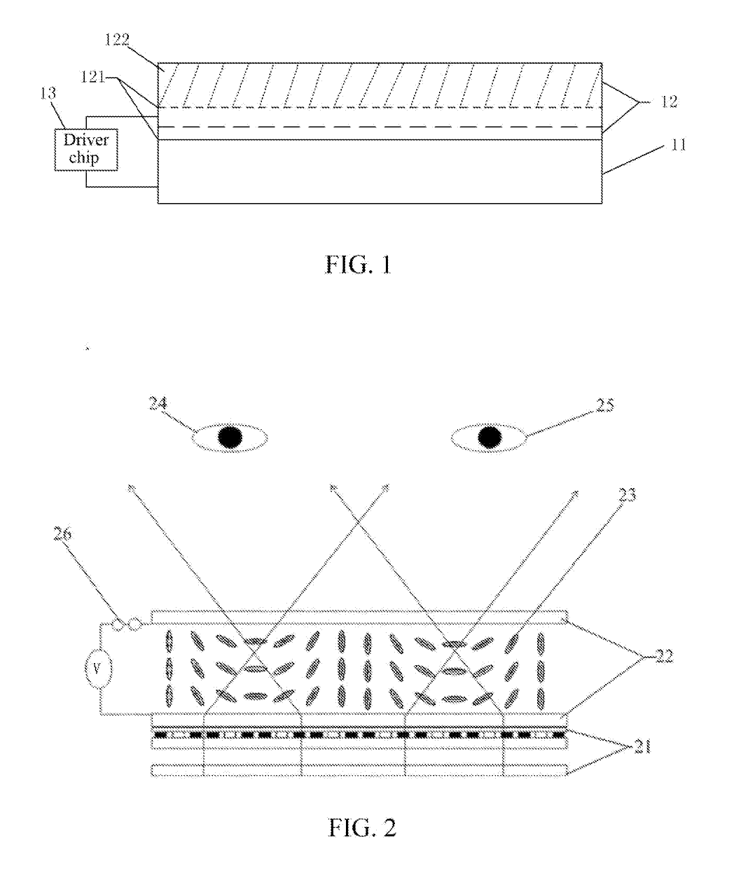

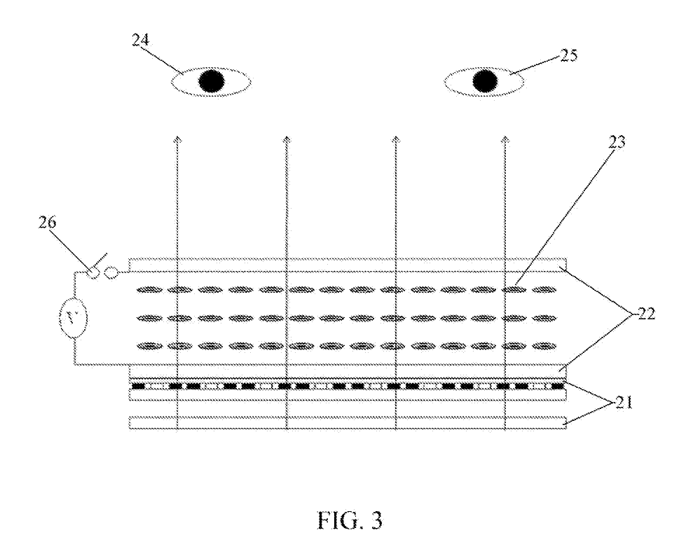

In the a specific embodiment of the present disclosure, taking a liquid crystal display screen 21 as an example, as shown in FIG. 2, the 3D display panel 11 includes the liquid crystal display screen 21 and a liquid crystal box 22 jointed above closely on the liquid crystal display screen 21. The liquid crystal box 22 forms a liquid crystal lens, and is arranged to form a 3D image. A transparent electrode array is etched on a glass of the liquid crystal box 22. When a voltage switch 26 is closed, i.e., when a driving voltage is applied to that array, liquid crystal molecules 23 in the liquid crystal box 22 are twisted to form the effect of a cylindrical lens. After the displayed image of the liquid crystal screen 21 passes through the cylindrical lens, images at two sides of a cylindrical surface enter a human left eye 24 and right eye 25 respectively to composite a stereo image through a human brain. The stereo image floats over the glass substrate 122 and is formed into a stereo database with a lateral dimension, a longitudinal dimension and a height dimension. When an operating body is above the glass substrate 122, the capacitive screen 121 senses position information in lateral and longitudinal directions on the upper surface of the glass substrate 122 where the operating body is located and signal intensity to form information about a plurality of points with lateral dimensions, longitudinal dimensions and height dimensions, and transmits the information to a driver chip 13. The driver chip 13 matches the information with stereo image information formed by the 3D display panel 11 to implement an interactive action. When the voltage switch 26 is opened, i.e., a driving voltage is not applied to the liquid crystal box 22, as shown in FIG. 3, the image of the liquid crystal screen 21 is projected vertically outside of the screen surface, and a 3D image is not formed and it is normal 2D display.

In an exemplary embodiment, the 3D display apparatus in accordance with the embodiment of the present disclosure further includes a signal monitoring chip, a signal determining chip and a signal extraction chip.

The signal monitoring chip is arranged to collect the first sensing signal and the second sensing signal.

The signal determining chip is arranged to determine a comparison result of intensities of the first sensing signal and the second sensing signal.

The signal extraction chip is arranged to extract the first sensing signal and send the first sensing signal to the driver chip 13 when the intensity of the first sensing signal is greater than the intensity of the second sensing signal, and extract the second sensing signal and send the second sensing signal to the driver chip 13 when the intensity of the second sensing signal is greater than the intensity of the first sensing signal.

In an exemplary embodiment, functions of the signal monitoring chip, the signal determining chip and the signal extraction chip may be integrated into one chip to implement.

In the embodiment of the present disclosure, after the capacitive screen 121 senses the first sensing signal and the second sensing signal, the signal monitoring chip will collect the first sensing signal and the second sensing signal, and the signal determining chip will compare the intensities of the two signals, and the signal extraction chip will extract a signal with the higher intensity and transmit the signal with the higher intensity to the driver chip 13 such that the driver chip 13 can determine an operation command of the operating body to the image displayed on the 3D display panel 11 according to the signal with the higher intensity to change the image of the 3D display panel 11.

In an exemplary embodiment, the capacitive screen 121 in accordance with the embodiment of the present disclosure includes a first capacitive layer and a second capacitive layer.

The first capacitive layer is a mutual capacitive structure and is arranged to sense a touch operation of the operating body on the surface of the glass substrate to generate the first sensing signal.

The second capacitive layer is a self capacitive structure and is laid on the first capacitive layer and located between the glass substrate 122 and the first capacitive layer. The second capacitive layer is arranged to sense a stereo operation of the operating body at a predefined distance outside the glass substrate 122 to generate the second sensing signal.

In the embodiment of the present disclosure, the capacitive screen 121 is a structure compatible with self capacitance and mutual capacitance. The self capacitance is arranged to be floating touch, i.e., stereo touch. The mutual capacitance is arranged to be a normal touch operation of the operating body touching the glass substrate 122. The self capacitance is a capacitance of an electrode on the capacitive screen to the ground, and the signal intensity of the self capacitance is high, and signal changes within a certain distance above the glass substrate 122 can be collected, thereby implementing stereo floating touch within a space at a certain distance above the glass substrate 122. The surface of the glass substrate 122 is divided into a plurality of regions to ensure that at most only one operating body is in activity in each of the regions, thereby implementing multi-touch under the self capacitance condition. Using the self capacitance scheme, the second sensing signal may be collected within a certain distance above the glass substrate 122. When the distances of the operating body from the upper surface of the glass substrate 122 are different, the signal intensities sensed by the self capacitance are different as well, therefore, the distance of the operating body from the glass substrate 122 is determined within the certain distance above the glass substrate 122 by the sensed signal intensity according to a matching relationship between the signal intensity and the distance. When the operating body touches the upper surface of the glass substrate 122, due to a huge difference between dielectric constants of the air and glass, the signal sensed by the self capacitance will change abruptly, and at the point the self capacitance will be switched to the mutual capacitance sensing signal and a touch sensing layer 12 senses the signal using a mutual capacitance manner. When the operating body leaves the surface of the glass substrate 122, the mutual capacitance will sense abrupt change of the signal, and at the point the mutual capacitance will be changed to the self capacitance sensing signal.

The mode of setting the second capacitive layer forming the self capacitive structure and the first capacitive layer forming the mutual capacitive structure on the display panel can be understood by those skilled in the art, and will not be described in detail herein.

In an exemplary embodiment, the driver chip 13 in accordance with the embodiment of the present disclosure includes a first coordinate determining structure, a first data acquiring structure, a first command determining structure and a first image output structure.

The first coordinate determining structure is arranged to determine a coordinate position of touch of the touch operation on the glass substrate 122 according to the first sensing signal.

The first data acquiring structure is arranged to determine an image content corresponding to the coordinate position.

The first command determining structure is arranged to determine an operation command corresponding to the image content according to the image content.

The first image output structure is arranged to change the image of the 3D display panel according to the operation command.

In the embodiment of the present disclosure, the first sensing signal is sensed by mutual capacitance. The mutual capacitance means capacitances at the intersection of the two groups of electrodes, i.e., the two groups of electrodes constitutes two poles of the capacitances respectively, herein lateral electrodes and longitudinal electrodes are fabricated from ITO (a transparent conducting material) on the glass surface. When the operating body touches the glass substrate 122, coupling between two electrodes near the touch point is affected, thereby changing the capacitance quantity between the two electrodes. As shown in FIG. 5, when the magnitude of the mutual capacitance is detected, the lateral electrodes send out excitation signals in turn, all of the longitudinal electrodes receive the signals simultaneously to obtain the magnitude of a capacitance value at the intersections of all of the lateral electrodes and longitudinal electrodes, i.e., the magnitude of capacitances of a two-dimensional plane of the whole touch screen. A coordinate position, i.e., X-axis and Y-axis, of each touch point may be calculated based on variation data of two-dimensional capacitance of the touch screen. Therefore, even if there are a plurality of touch points on the screen, a true coordinate of each touch point can be calculated to determine the coordinate of the touch point while determining an image content corresponding to the touch point. In an exemplary embodiment, the operation command corresponding to the image content is determined and the image of the 3D display panel 11 is changed according to the operation command.

In an exemplary embodiment, the driver chip 13 in accordance with the embodiment of the present disclosure further includes a second coordinate determining structure, a second data acquiring structure, a second command determining structure and a second image output structure.

The second coordinate determining structure is arranged to determine a vertical coordinate position of the stereo operation relative to the glass substrate 122 and a plane coordinate position of a projection of the stereo operation on a surface of the glass substrate 122 according to the second sensing signal.

The second data acquiring structure is arranged to determine an image content operated by an interactive operation according the vertical coordinate position and the plane coordinate position.

The second command determining structure is arranged to determine an operation command corresponding to the image content according to the image content.

The second image output structure is arranged to change the image of the 3D display panel 11 according to the operation command.

In the embodiment of the present disclosure, the second sensing signal is sensed by self capacitance. The self capacitance means capacitances which are formed by lateral and longitudinal electrodes with the ground, i.e., capacitances of the electrodes to the ground, herein, a lateral electrode array and a longitudinal electrode array are fabricated from Indium Tin Oxides ITO (a transparent conducting material) on the glass surface. When the operating body is within a certain distance above the glass substrate 122, the signal monitoring chip can collect changes in the signal. The capacitance of the operating body will be superposed on the capacitance of the touch screen body such that the capacitance of the screen body increases. Upon touch detection, the self capacitive screen 121 detects in turn the lateral electrode array and longitudinal electrode array respectively, and determines a lateral coordinate and a longitudinal coordinate to combine into a planar touch coordinate according to changes of capacitances before and after the touch. When the distances of the operating body from the upper surface of the glass substrate 122 are different, the capacitance values of the operating body superposed on the second capacitive layer are different as well. The farther the operating body is from the glass substrate 122, the smaller the capacitance value is. Therefore, the height of the operating body from the upper surface of the glass substrate 122 corresponds to a capacitance value to form a database. Thus, the distance of the operating body from the glass substrate 122, i.e., the vertical position of the operating body relative to the glass substrate 122, may be determined through the corresponding relationship. Therefore, the vertical coordinate position of the operating body relative to the glass substrate 122 and the plane coordinate position of a projection of the operating body on the surface of the glass substrate 122 are determined. While a position of the operating point is determined, an image content corresponding to the operating point is determined according to depth data of the currently output image. In an exemplary embodiment, the operation command corresponding to the image content is determined and the image of the 3D display panel 11 is changed according to the operation command.

In an exemplary embodiment, the second capacitive layer in accordance with the embodiment of the present disclosure includes a plurality of sub-regions arranged to sense stereo operations in different sub-regions to generate a plurality of second sensing signals.

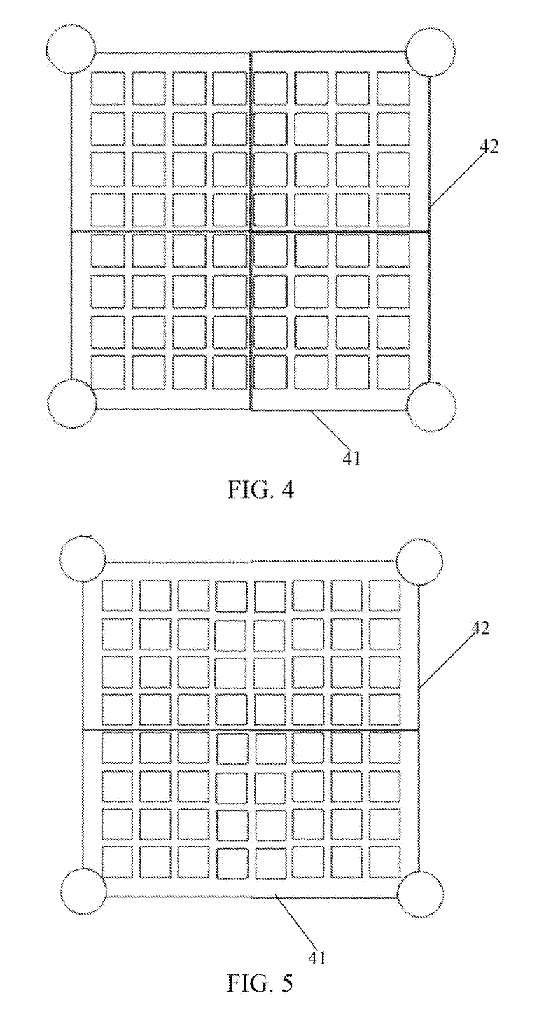

In the embodiment of the present disclosure, the second capacitive layer is a self capacitive structure. A scanning mode of the self capacitance, as shown in FIG. 4, is equivalent to project the touch point on the touch screen onto directions of X-axis 41 and Y-axis 42 respectively, and calculate coordinates in the directions of X-axis 41 and Y-axis 42 respectively to combine into the coordinate of the touch point finally. In such mode, in the case of single touch, projections on both directions of X-axis 41 and Y-axis 42 are unique, and the combined coordinate is unique. However, if there are two or more operating bodies and the two points are not in the same X direction or the same Y direction, then there are two projections in the X and Y directions respectively to combine into 4 coordinates. Herein, only two of the 4 coordinates are real, and the other two are ghost points. Therefore, in the embodiment of the present disclosure, the second capacitive layer is divided into a plurality of regions, the number of which is appropriately determined by the size of the screen of a terminal. Taking 4 regions as an example, as shown in FIG. 4, different operations fall into different regions, and there is only one operating body in each region. Thus, one point can be collected accurately in each region, and a plurality of points can be collected by combining different regions together to implement multi-touch touch. Therefore, the collection of multi-touch signals is implemented in the directions of X-axis 41 and Y-axis 42 on the surface of the touch screen of a cell phone.

It should be noted that the embodiment of the present disclosure may be applied to various scenarios. For example, in 3D stereo games such as a fishing game, the 3D display panel 11 displays a stereo fish swimming in the water. Two fingers may pinch the fish above the glass substrate 122, increasing fun in the game. Taking unlocking of the screen of a cell phone with a stereo gesture as an example, a stereo gesture of multiple fingers in a stereo space may be stored to implement a stereo unlocking screen. Changes in the intensity may be achieved using changes in the height of the finger from the upper surface of the glass substrate 122, such as changes in the thickness of a character written with a brush, changes in strength of sound when playing the piano. Application scenarios in which stereo display and stereo touch interactive operations are implemented are very broad.

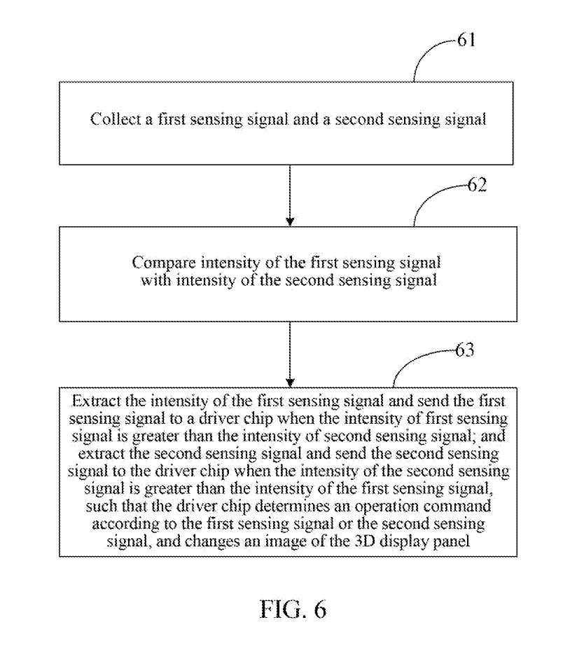

As shown in FIG. 6, an embodiment of the present disclosure further provides a sensing method for the 3D display apparatus including steps 61-63.

In step 61, it is to collect a first sensing signal and a second sensing signal.

In step 62, it is to compare intensity of the first sensing signal with intensity of the second sensing signal.

In step 63, it is to extract the first sensing signal and send the first sensing signal to a driver chip 13 when the intensity of the first sensing signal is greater than the intensity of the second sensing signal; and extract the second sensing signal and send the second sensing signal to the driver chip 13 when the intensity of the second sensing signal is greater than the intensity of the first sensing signal, such that the driver chip 13 determines an operating command according to the first sensing signal or the second sensing signal and changes an image of a 3D display panel 11.

In the embodiment of the present disclosure, the first sensing signal sensed by a first capacitive layer and the second sensing signal sensed by a second capacitive layer are collected, and the intensities of the two signals are compared, and a signal with the higher intensity is extracted and transmitted to the driver chip 13, such that the driver chip 13 determines an operation command according to the signal with the higher intensity and changes the image of the 3D display panel 11 according to the operation command.

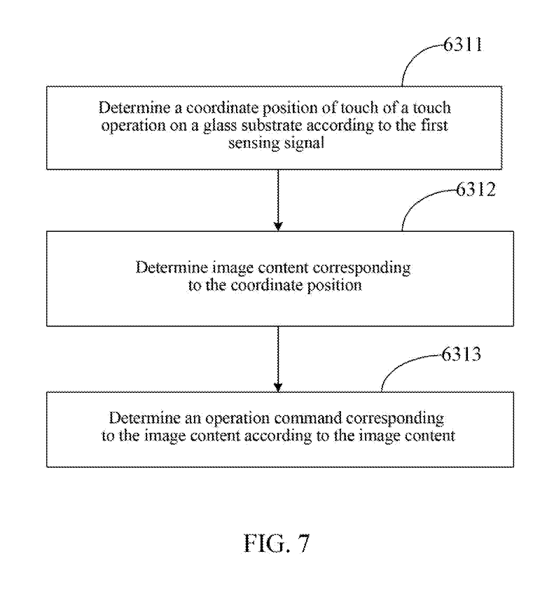

In an exemplary embodiment, as shown in FIG. 7, if the intensity of the first sensing signal is greater the intensity of the second sensing signal, the step that the driver chip 13 determines the operation command according to the first sensing signal includes steps 6311-6313.

In step 6311, it is to determine a coordinate position of touch of a touch operation on a glass substrate 122 according to the first sensing signal.

In step 6312, it is to determine an image content corresponding to the coordinate position.

In step 6313, it is to determine an operation command corresponding to the image content according to the image content.

In the embodiment of the present disclosure, after receiving the first sensing signal, the driver chip 13 will determine the coordinate position of the touch operation on the glass substrate 122 and determine the image content corresponding to the coordinate position as well according to the first sensing signal, to determine the operation command corresponding to the image content, such that the driver chip 13 changes the image of the 3D display panel 11 according to the operation command.

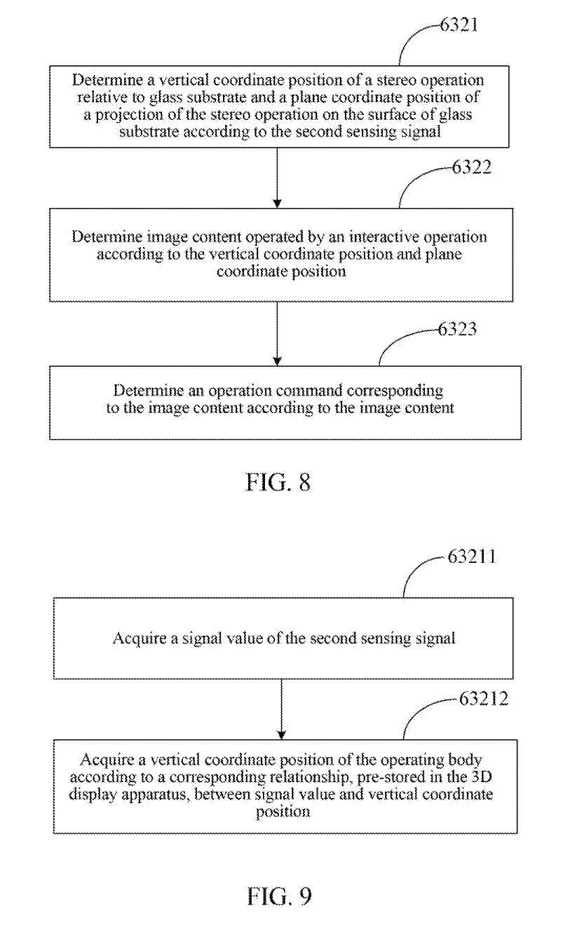

In an exemplary embodiment, as shown in FIG. 8, if the intensity of the second sensing signal is greater the intensity of the first sensing signal, the step that the driver chip 13 determines the operation command according to the second sensing signal includes steps 6321-6323.

In step 6321, it is to determine a vertical coordinate position of a stereo operation relative to the glass substrate 122 and a plane coordinate position of a projection of the stereo operation on a surface of the glass substrate 122 according to the second sensing signal.

In step 6322, it is to determine an image content operated by an interactive operation according the vertical coordinate position and the plane coordinate position.

In step 6323, it is to determine an operation command corresponding to the image content according to the image content.

In the embodiment of the present disclosure, after receiving the second sensing signal, the driver chip 13 will determine the coordinate position of the stereo operation on the glass substrate 122 and determine the image content corresponding to the coordinate position as well according to the second sensing signal, to determine the operation command corresponding to the image content, such that the driver chip 13 changes the image of the 3D display panel 11 according to the operation command.

In an exemplary embodiment, as shown in FIG. 9, in the embodiment of the present disclosure, the step of determining the vertical coordinate position of the stereo operation relative to the glass substrate 122 includes step 63211 and step 63212.

In step 63211, it is to acquire a signal value of the second sensing signal.

In step 63212, according to a corresponding relationship, pre-stored in the 3D display apparatus, between the signal value and the vertical coordinate position, it is to acquire a vertical coordinate position of an operating body.

In the embodiment of the present disclosure, since the distances of the operating body from the upper surface of the glass substrate 122 are different, the capacitance values of the operating body superposed on the second capacitive layer are different, i.e., the signal values of the second sensing signals are different. The farther the operating body is from the glass substrate 122, the smaller the superposed capacitance value is. Therefore, the height of the operating body from the upper surface of the glass substrate 122 corresponds to the capacitance value, i.e., the signal value of the second sensing signal, which forms a database. Thus, the height, i.e., the vertical coordinate position, of the operating body may be obtained by obtaining the capacitance value of the second capacitive layer, i.e., the signal value of the second sensing signal.

It should be noted that all the embodiments of the method described above are applicable to the 3D display apparatus in accordance with the present disclosure.

An embodiment of the present disclosure further provides a computer readable storage medium where computer executable instructions are stored, and the computer executable instructions are used for executing the method described above.

Those skilled in the art can understand that all or part of steps in the embodiment described above can be carried out using computer program flows. The computer program may be stored a computer readable medium and executed on a corresponding hardware platform (such as system, device, apparatus, appliance, etc.). When the computer program is executed, one of the steps or a combination thereof in the method embodiments may be executed.

Alternatively, all or part of the steps in the embodiment described above may also be implemented using integrated circuits. These steps may be fabricated into separated integrated circuit modules respectively, or a plurality of modules or steps of them may be fabricated into a single integrated circuit module.

Various apparatus/functional modules/functional units in the embodiment described above may be implemented using general-purpose computing apparatuses. They may be centralized on a single computing apparatus, or may be distributed in a network composed of a plurality of computing apparatuses.

When various apparatus/functional modules/functional units in the embodiment described above are implemented in a form of software function module or sold or used as independent products, they can be stored in a computer readable storage medium. The computer readable storage medium mentioned above may be a read only memory, a magnetic disk or optical disk or the like.

The above description is the alternative embodiments of the present disclosure only and is not intended to limit the protection scope of the present disclosure.

### INDUSTRIAL APPLICABILITY

The 3D display apparatus and sensing method for the 3D display apparatus provided by the embodiments of the present disclosure use built-in capacitive screen of the 3D display apparatus to collect stereo touch signals above a surface of a glass substrate, and form a terminal with stereo display and interactively operational functions together with the 3D display panel, such that the 3D display apparatus according to the embodiments of the present disclosure has good portability and can implement stereo multi-touch. Therefore more application scenarios of operations can be implemented, and the user experience is greatly enhanced.

1. A three dimensional, 3D, display apparatus comprising:
a 3D display panel arranged to form a 3D display image;
a touch sensing layer provided at a light-out side of the 3D display panel, wherein, the touch sensing layer comprises a capacitive screen and a glass substrate; wherein the glass substrate is laid on the capacitive screen, and the capacitive screen is arranged to sense a touch operation of an operating body on a surface of the glass substrate to generate a first sensing signal, and sense a stereo operation of the operating body at a predefined distance outside the glass substrate to generate a second sensing signal; and
a driver chip arranged to determine an operation command of the touch operation on the image displayed on the 3D display panel according to the first sensing signal to change the image of the 3D display panel, and also arranged to determine an operation command of the stereo operation on the image displayed on the 3D display panel according to the second sensing signal to change the image of the 3D display panel.

2. The 3D display apparatus according to claim 1, wherein the capacitive screen comprises:
a first capacitive layer, which is a mutual capacitive structure and is arranged to sense the touch operation of the operating body on the surface of the glass substrate to generate the first sensing signal; and
a second capacitive layer, which is a self capacitive structure and is laid on the first capacitive layer and located between the glass substrate and the first capacitive layer, and is arranged to sense the stereo operation of the operating body at the predefined distance outside the glass substrate to generate the second sensing signal.

3. The 3D display apparatus according to claim 2, further comprising:
a signal monitoring chip arranged to collect the first sensing signal and the second sensing signal;
a signal determining chip arranged to determine a comparison result of intensities of the first sensing signal and the second sensing signal; and
a signal extraction chip arranged to extract the first sensing signal and send the first sensing signal to the driver chip when the intensity of the first sensing signal is greater than the intensity of the second sensing signal, and extract the second sensing signal and send the second sensing signal to the driver chip when the intensity of the second sensing signal is greater than the intensity of the first sensing signal.

4. The 3D display apparatus according to claim 1, wherein the driver chip comprises:
a first coordinate determining structure arranged to determine a coordinate position of touch of the touch operation on the glass substrate according to the first sensing signal;
a first data acquiring structure arranged to determine an image content corresponding to the coordinate position;
a first command determining structure arranged to determine an operation command corresponding to the image content according to the image content; and
a first image output structure arranged to change the image of the 3D display panel according to the operation command.

5. The 3D display apparatus according to claim 4, wherein the driver chip further comprises:
a second coordinate determining structure arranged to determine a vertical coordinate position of the stereo operation relative to the glass substrate and a plane coordinate position of a projection of the stereo operation on a surface of the glass substrate according to the second sensing signal;
a second data acquiring structure arranged to determine an image content operated by an interactive operation according to the vertical coordinate position and the plane coordinate position;
a second command determining structure arranged to determine an operation command corresponding to the image content according to the image content; and
a second image output structure arranged to change the image of the 3D display panel according to the operation command.

6. The 3D display apparatus according to claim 2, wherein the second capacitive layer comprises a plurality of sub-regions, and the plurality of sub-regions are arranged to sense stereo operations in different sub-regions to generate a plurality of second sensing signals.

7. A sensing method for the 3D display apparatus according to claim 1, comprising:
collecting the first sensing signal and the second sensing signal;
determining a comparison result of intensities of the first sensing signal and the second sensing signal; and
extracting the first sensing signal and sending the first sensing signal to the driver chip when the intensity of the first sensing signal is greater than the intensity of the second sensing signal; extracting the second sensing signal and sending the second sensing signal to the driver chip when the intensity of the second sensing signal is greater than the intensity of the first sensing signal, such that the driver chip determines an operation command according to the first sensing signal or the second sensing signal to change the image of the 3D display panel.

8. The sensing method according to claim 7, wherein the step of the driver chip determining an operation command according to the first sensing signal comprises:
determining a coordinate position of touch of the touch operation on the glass substrate according to the first sensing signal;
determining an image content corresponding to the coordinate position; and
determining an operation command corresponding to the image content according to the image content.

9. The sensing method according to claim 7, wherein the step of the driver chip determining an operation command according to the second sensing signal comprises:
determining a vertical coordinate position of a stereo operation relative to the glass substrate and a plane coordinate position of a projection of the stereo operation on a surface of the glass substrate according to the second sensing signal;
determining an image content operated by an interactive operation according the vertical coordinate position and the plane coordinate position; and
determining an operation command corresponding to the image content according to the image content.

10. The sensing method according to claim 9, wherein the step of determining a vertical coordinate position of a stereo operation relative to the glass substrate comprises:
acquiring a signal value of the second sensing signal; and
acquiring the vertical coordinate position of the operating body according to a corresponding relationship, pre-stored in the 3D display apparatus, between the signal value and the vertical coordinate position.

11. A computer readable storage medium where computer executable instructions are stored, wherein the computer executable instructions are used for executing the method according to claim 7.

12. A sensing method for the 3D display apparatus according to claim 2, comprising:
collecting the first sensing signal and the second sensing signal;
determining a comparison result of intensities of the first sensing signal and the second sensing signal; and
extracting the first sensing signal and sending the first sensing signal to the driver chip when the intensity of the first sensing signal is greater than the intensity of the second sensing signal; extracting the second sensing signal and sending the second sensing signal to the driver chip when the intensity of the second sensing signal is greater than the intensity of the first sensing signal, such that the driver chip determines an operation command according to the first sensing signal or the second sensing signal to change the image of the 3D display panel.

13. A sensing method for the 3D display apparatus according to claim 3, comprising:
collecting the first sensing signal and the second sensing signal;
determining a comparison result of intensities of the first sensing signal and the second sensing signal; and
extracting the first sensing signal and sending the first sensing signal to the driver chip when the intensity of the first sensing signal is greater than the intensity of the second sensing signal; extracting the second sensing signal and sending the second sensing signal to the driver chip when the intensity of the second sensing signal is greater than the intensity of the first sensing signal, such that the driver chip determines an operation command according to the first sensing signal or the second sensing signal to change the image of the 3D display panel.

14. A sensing method for the 3D display apparatus according to claim 4, comprising:
collecting the first sensing signal and the second sensing signal;
determining a comparison result of intensities of the first sensing signal and the second sensing signal; and
extracting the first sensing signal and sending the first sensing signal to the driver chip when the intensity of the first sensing signal is greater than the intensity of the second sensing signal; extracting the second sensing signal and sending the second sensing signal to the driver chip when the intensity of the second sensing signal is greater than the intensity of the first sensing signal, such that the driver chip determines an operation command according to the first sensing signal or the second sensing signal to change the image of the 3D display panel.

15. A sensing method for the 3D display apparatus according to claim 5, comprising:
collecting the first sensing signal and the second sensing signal;
determining a comparison result of intensities of the first sensing signal and the second sensing signal; and
extracting the first sensing signal and sending the first sensing signal to the driver chip when the intensity of the first sensing signal is greater than the intensity of the second sensing signal; extracting the second sensing signal and sending the second sensing signal to the driver chip when the intensity of the second sensing signal is greater than the intensity of the first sensing signal, such that the driver chip determines an operation command according to the first sensing signal or the second sensing signal to change the image of the 3D display panel.

16. A sensing method for the 3D display apparatus according to claim 6, comprising:
collecting the first sensing signal and the second sensing signal;
determining a comparison result of intensities of the first sensing signal and the second sensing signal; and
extracting the first sensing signal and sending the first sensing signal to the driver chip when the intensity of the first sensing signal is greater than the intensity of the second sensing signal; extracting the second sensing signal and sending the second sensing signal to the driver chip when the intensity of the second sensing signal is greater than the intensity of the first sensing signal, such that the driver chip determines an operation command according to the first sensing signal or the second sensing signal to change the image of the 3D display panel.
